(19) United States
(12) Patent Application Publication
(10) Pub. No.: US 2026/0220878 A1
(43) Pub. Date: Jul. 30, 2026

(54) Rendering Flying Object Traces On Computing Devices

(71) Applicant: TOPGOLF SWEDEN AB, Danderyd (SE)

(72) Inventor: Johan Riddersporre, Tullinge (SE)

(21) Appl. No.: 19/149,065

(22) PCT Filed: Jan. 17, 2024
(86) PCT No.: PCT/EP2024/051081

§ 371 Date: Jul. 17, 2025

(30) Foreign Application Priority Data
Jan. 19, 2023 (SE) 2330035-3

(51) Int. Cl. G06T 15/20; A63B 24/00; A63B 71/06; A63F 13/52; A63F 13/573; A63F 13/65; A63F 13/812

(52) U.S. Cl. CPC G06T 15/205; A63B 24/0021; A63B 71/0622; A63F 13/52; A63F 13/573; A63F 13/65; A63F 13/812; A63B 2024/0028; A63B 2071/0636; A63B 2220/806; A63B 2220/89; G06T 2215/16

(57) ABSTRACT

A three-dimensional rendering method for a computing device includes: receiving a color buffer, a depth buffer, and one or more three-dimensional viewing parameters, the color buffer providing a two-dimensional representation of a three-dimensional space; receiving trace data representing a trajectory of a flying object in the three-dimensional space; rendering a trace from the trace data representing the trajectory on top of the received color buffer, and using depth buffer data to determine whether the trace of the flying object should be occluded by any objects in the received color buffer; and drawing the color buffer with the rendered trace on a display device. Methods, systems, and computer program products for preparing data representing a three-dimensional scene to be rendered on a computing device are also described.

### BACKGROUND

The present invention relates to rendering two-dimensional (2D) information about a three-dimensional (3D) environment on a computing device, and more specifically to displaying trajectory information for flying objects, such as sports balls moving through the air.

When playing sports games that involve launching a ball into the air, such as golf or baseball, for example, it is often interesting to be able to view a replay of the shot for a variety of reasons, such as, for training purposes to improve the skills of the player. For example, a golf shot can be replayed and studied by a professional trainer, who may provide feedback to the player with respect to how to change the shot in order to achieve better results, and then view the replay of the shot to see what changed as a result of following the instructor's advice. Of course, replay can also be done for entertainment purposes, for example, if a player wants to show their peers how a particular shot played out on the golf course.

In the case of a golf game, often, one or more doppler radars and/or one or more cameras are used to track the golf ball, and a trajectory for the ball is created by registering a series of three-dimensional positions for the ball in the air, along with their respective times. However, this tracking only pertains to the golf ball itself and does not contain any information about the surroundings. In order to obtain such information and visualize the actual movement of the ball through the air and in the setting where the ball is actually launched, one can record a video (i.e., a series of pictures) of the ball flying through the air.

A single screen shot in full high definition (HD), such as 1920×1080 pixels requires approximately 6 MB of raw data. Even if the screen shot is compressed into a different format such as the Joint Photographic Experts Group (JPG) format, it would require approximately 200 kB per shot. Assuming a volume of about 5 billion shots per year, the storage alone of these shots (in a compressed format) would require approximately 1000 TB of data per year, for a shot from a single angle. Further, an animation of a shot would require approximately 20 MB per shot, i.e., an additional 100-fold more storage compared to a JPG still image will be needed.

### SUMMARY

In some aspects, the techniques described herein relate to a three-dimensional rendering method for a computing device, including: receiving a color buffer, a depth buffer, and one or more three-dimensional viewing parameters, the color buffer providing a two-dimensional representation of a three-dimensional space; receiving trace data representing a trajectory of a flying object in the three-dimensional space; rendering a trace from the trace data representing the trajectory on top of the received color buffer, and using depth buffer data to determine whether the trace of the flying object should be occluded by any objects in the received color buffer; and drawing the color buffer with the rendered trace on a display device.

In some embodiments, the three-dimensional viewing parameters include a model viewport projection matrix, and wherein the model viewport projection matrix is used when rendering the trace on top of the color buffer.

In some embodiments, receiving the color buffer includes preloading the color buffer separately from receiving the trace data.

In some embodiments, the trace data includes a series of points in three-dimensional space and a corresponding time for each point.

In some embodiments, rendering the trace includes rendering the trace either statically based on the series of points, or rendering the trace dynamically as an animation based on the series of points and the corresponding time for each point.

In some embodiments, the color buffer represents an image of an environment through which the flying object passes.

In some aspects, the techniques described herein relate to a method to 5, wherein the color buffer represents a three-dimensional animated view in a game.

In some embodiments, the method is performed a plurality of times for different color buffers, depth buffers, traces, and/or three-dimensional viewing parameters and wherein the color buffers with the traces are drawn in several smaller sections within a browser window on the computing device.

In some embodiments, the method further includes rendering one or more optional objects on top of the color buffer.

In some embodiments, the one or more optional objects include static or movable objects.

In some embodiments, the method further includes receiving a selection of one or more color buffers among a plurality of color buffers, or automatically selecting one or more color buffer among a plurality of color buffers.

In some embodiments, the method further includes rendering several traces representing several trajectories of the same flying object under different circumstances, or several trajectories representing different flying objects.

In some embodiments, the trace data is received in a compressed format and is decompressed by the computing device prior to rendering the trace.

In some embodiments, the display device is integrated in the computing device.

In some aspects, the techniques described herein relate to a system for rendering a three-dimensional scene on a computing device, including a memory; and a processor, wherein the memory contains instructions that, when executed by the processor perform the method as described above.

In some aspects, the techniques described herein relate to a non-transitory, computer-readable storage medium containing instructions that when executed by a computing device cause the computing device to perform the method as described above.

In some aspects, the techniques described herein relate to a method for preparing data representing a three-dimensional scene to be rendered on a computing device, including: obtaining a color buffer, a depth buffer, and one or more three-dimensional viewing parameters, the color buffer providing a two-dimensional representation of a three-dimensional space; obtaining trace data representing a trajectory of a flying object in the three-dimensional space; storing the obtained color buffer, depth buffer and three-dimensional viewing parameters separately from the obtained trace data; and sending the color buffer, the depth buffer, the three-dimensional viewing parameters, and the trace data, to the computing device for rendering the three-dimensional scene on the computing device, wherein the trace data is sent separately from the color buffer, the depth buffer and the three-dimensional viewing parameters.

In some embodiments, the three-dimensional viewing parameters include a model viewport projection matrix to be used when rendering the trace on top of the color buffer on the computing device.

In some embodiments, the color buffer represents an image of an environment through which the flying object passes.

In some embodiments, the color buffer represents a three-dimensional animated view from a first viewpoint.

In some embodiments, the trace data includes a series of points in three-dimensional space and a corresponding time for each point.

In some embodiments, storing the trace data includes: compressing the trace data; and storing the trace data in a compressed format.

In some embodiments, the method further includes obtaining and storing several trajectories of the same flying object under different circumstances, or several trajectories representing different flying objects.

In some aspects, the techniques described herein relate to a system for preparing data representing a three-dimensional scene to be rendered on a computing device, including a memory; and a processor, wherein the memory contains instructions that, when executed by the processor perform the method described above.

In some aspects, the techniques described herein relate to a non-transitory, computer-readable storage medium containing instructions that when executed by a computing device cause the computing device to perform the method described above.

The details of one or more embodiments of the invention are set forth in the accompanying drawings and the description below. Other features and advantages of the invention will be apparent from the description and drawings, and from the claims.

### BRIEF DESCRIPTION OF THE DRAWINGS

In the following, the invention will be described in detail, with reference to exemplifying embodiments of the invention and to the enclosed drawings, wherein:

FIG. 1 is a flowchart showing a 3D rendering method, in accordance with some embodiments.

FIG. 2 is a block diagram showing a computing device, in accordance with some embodiments.

FIG. 3 shows a rendition of a set of pre-rendered graphics objects on a graphical user interface on a computing device, in accordance with some embodiments.

FIG. 4 illustrates a graphical user interface including a pre-rendered graphics object with a trace, in accordance with some embodiments.

FIG. 5 illustrates a graphical user interface including a pre-rendered graphics object with multiple traces, in accordance with some embodiments.

FIG. 6 is a block diagram of a system for rendering trace data, in accordance with some embodiments.

FIG. 7 is a flowchart showing a server method for providing data representing a 3D scene to a computing device, in accordance with some embodiments.

Like reference symbols in the various drawings indicate like elements.

### DETAILED DESCRIPTION

The various embodiments of the invention pertain to techniques for rendering a replay of a ball's trajectory (e.g., a golf shot) in a lightweight and efficient way without requiring significant data storage or bandwidth usage. In some embodiments, this can be accomplished by receiving color buffer, depth buffer, and 3D viewing parameters, which together describe a scene, such as a hole at a golf course. Recorded trace data for a golf ball being played at the hole is stored separately from the color buffer, depth buffer, and 3D viewing parameters, and a trace of the golf ball is recreated in the scene at a later stage, by a computing device (e.g., a laptop, tablet computer, mobile phone, or the like). By using the same coordinate system for the trace data and the scene, it is possible to apply the depth buffer to the tracked object (e.g., the golf ball) to determine whether the tracked object should be occluded or not by other objects in the scene. The tracked object can then be rendered in to the color buffer to create a 2-D image that also includes the tracked object that is to be displayed on the computing device.

Various embodiments of the subject matter described in this specification can be implemented to realize one or more of the following advantages. The trajectory of a flying object can be readily viewed, e.g., a golf shot can be replayed, on a computing device, such as a cellular phone, without requiring downloading large amounts of image data, thus reducing bandwidth requirements for a computer network to which the computing device is attached. A lightweight rendering of ball trajectory replays can be provided, for example, in a web browser so the replays can be viewed on any device without requiring powerful Graphics Processing Units (GPUs), complex 3D rendering engines, or significant storage space on the device, allowing a user to view replays of their shots in a relevant context, as well as comparing them to other players or historical data. This can be employed either in an educational way, e.g., together with a coach or teacher, to see how the user has executed lessons or tasks, or for entertainment purposes, such as sharing hole-in-one shots with one's peers on social media, for example.

In order to appreciate the various features and benefits of the invention more fully, a brief general overview of how 3D rendering engines work will first be provided. It should be noted that the following is a simplified explanation that is presented for purposes of illustrating general concepts relating to 3D rendering and that many implementation details have been excluded clarity reasons.

In general, a 3D rendering engine can be described as a software component that is responsible for generating a 2D image from a 3D model. The 3D rendering engine does so by simulating how light interacts with the surface of objects in a virtual scene, considering factors such as the color and texture of the objects, the position and intensity of lights, and the perspective of the camera. 3D rendering engines are used in a variety of applications, including computer games, movies, and architectural visualization. They are also used in scientific and engineering simulations, such as fluid dynamics and structural analysis. There are many different 3D rendering engines available, ranging from commercial software packages to open-source projects.

The 2D image that is the output from the 3D rendering engine is a 2D projection of the 3D model, and is commonly referred to as a color buffer (i.e., a region of memory that holds the color data for the image). The 3D engine computes where all the 3D objects will be visible in the color buffer and sets the colors (i.e., data values) of the different pixels in the color buffer accordingly. A transformation between the 3D world objects and the 2D image is referred to as a Model Viewport Projection (MVP) matrix. The MVP matrix is usually determined by a camera object and viewport parameters (CV parameters).

In a 3D scene, some objects may be located “behind” other objects when viewing them from the camera's point of view. In order to avoid drawing objects that are obscured by other objects from the camera's viewpoint, a depth buffer is used. The depth buffer is typically a buffer having the same pixel or bitmap size as the color buffer, but including data values that describe a depth for each pixel in the depth buffer, i.e., describing how far from the camera the various objects visible in the color buffer are located.

Thus, rendering a scene in a 3D-world, can be done as follows:
1. Clear the color buffer and the depth buffer.
2 For each object in the scene:
   a. Transform the object to the image coordinate system, using the MVP matrix.
   b. Compare the object's distance from the camera in the image coordinate system to the current depth buffer value. If the distance is less than the current depth buffer value, draw the color of the object (i.e., set the data values for the individual pixels forming the object) in the color buffer, and update the depth buffer data values.
3. Draw the resulting color buffer on the screen.

A 3D rendering method in accordance with some embodiments of the invention will now be described by way of example and with reference to the figures, followed by a brief description of a general-purpose computing device that can be used in various embodiments to perform these functions. Finally, a system will also be described, in accordance with some embodiments, which illustrates various components and their interactions to achieve the functionality of the method.

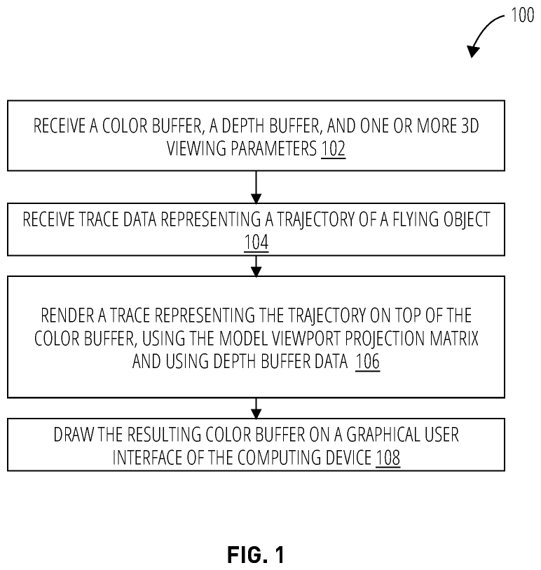

As shown in FIG. 1, in some embodiments, in block 102, a 3D rendering method 100 receives a color buffer, a depth buffer, and one or more 3D viewing parameters, such as CV parameters. The resolution of the color buffer and depth buffer, respectively, depends on the particular implementation. In some implementations, the color buffer and depth buffer have the same resolution, but it is also possible for the color buffer and the depth buffer to have different resolutions. The CV parameters can include a model viewport projection matrix, which is a common way to describe 3D-to-2D transformations. It should be realized that the MVP matrix does not have to be included, and that in some implementations, the CV parameters are sent in a different format, as long as they accurately represent the position and orientation of the camera in an unambiguous manner, and then the MVP matrix is computed based on those parameters.

The combination of color buffer, depth buffer and CV parameters together represent a 3D view of a portion of a virtual or physical environment, such as a golf course, e.g., in a computer game. While a computer game will be used by way of example herein, it should be noted that in some embodiments, a camera can depict a scene from a real-world golf course, combined with collected depth information (for example, by using LIDAR (Laser Imaging, Detection, and Ranging) techniques), to obtain information about the real world 3D environment. The view can be from any angle and zoomed in/out at any level. For example, there may be a birds-eye view showing the entire golf course, there may be a view showing a particular hole, or there may be a zoomed-in view showing only the vicinity of the flag at the end of a hole, or anything in between. For ease of explanation, the combination of color buffer, depth buffer and CV parameters will be collectively referred to herein as a “pre-rendered graphics object.”

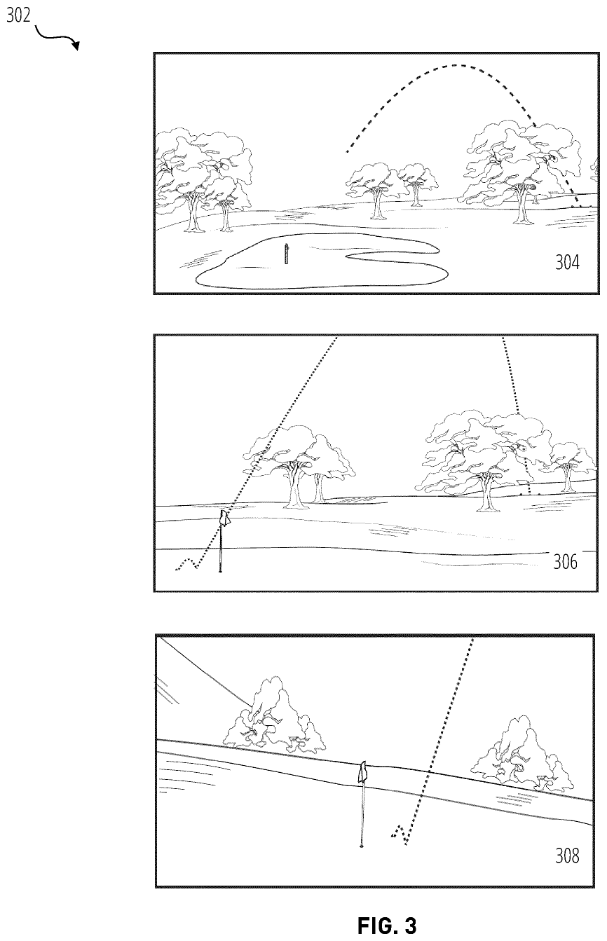

Each hole in a game may have several associated pre-rendered graphics objects, which together form a set. FIG. 3 shows schematically a stylized version of a set of pre-rendered graphics objects 302, comprising pre-rendered graphics objects 304-308. It should be noted that while FIG. 3 is illustrated in black and white line drawings, in a real-world implementation, each view would be a rendered color buffer containing a variety of colors and significant detail. The set of pre-rendered graphics objects 302 illustrated in FIG. 3 contains three pre-rendered graphics objects 304-308, which represent different scenes or views of a hole of a golf course. The sets of pre-rendered graphics objects 302 can be created at any time, but are typically created in conjunction with developing a new game, or if there has been any updates or improvements to images used in an existing game. The pre-rendered graphics objects 304-308 can be modified at any time, so long as the coordinate system remains the same, and the set of pre-rendered graphics objects 302 has all the information about the individual pre-rendered graphics objects 304-308 that together form the set 302.

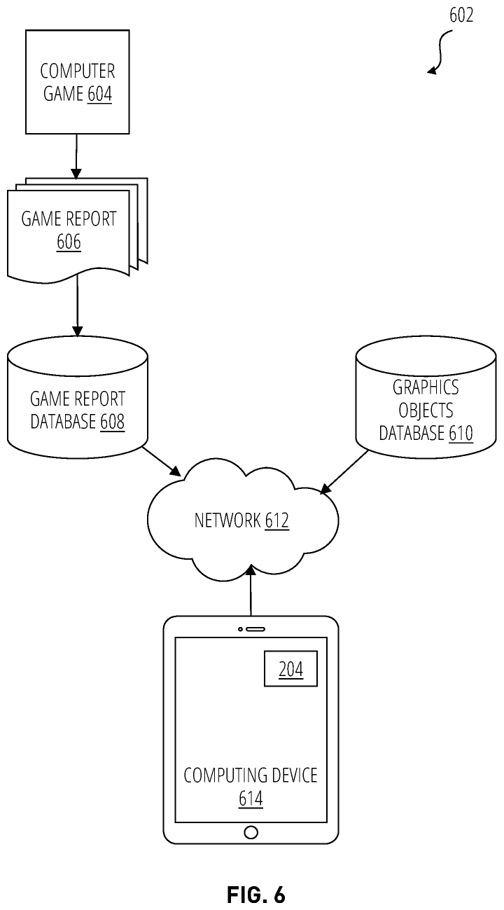

As will be described in further detail with respect to FIG. 6, in some embodiments, the sets of pre-rendered graphics objects 302 are created, stored, and used as a shared resource. In order for various applications to be able to find and access the correct set of pre-rendered graphics objects 302, the set of pre-rendered graphics objects 302 has an associated identifier. The identifier can, for example, be derived from the game played. As an example, an identifier can have the format “aa_bb_hole #,” where aa is an abbreviation of the game mode, bb is a configuration, and hole # is the hole number in the game mode. Exactly how and where the identifier, pre-rendered graphics objects 304-308 are associated and stored depends on the particular implementation at hand, as will be discussed in further detail with respect to the description of the system 602.

Next, in block 104, 3D rendering method 100 receives trace data representing a trajectory of a flying object. When a game is played by a user, measured and/or estimated data is obtained about instantaneous locations of a ball as the ball travels through the air, which is typically referred to as a “trace.” This trace data can be obtained in a variety of ways, but usually involve one or more radar sensors and/or one or more cameras. Thus, in a typical embodiment, the trace is a collection of points in 3D space, with corresponding times. As will be described in further detail below with reference to the system description, the collection of points, associated times, and other metadata is sent to storage, from which it can later be retrieved. Typically, the sets of pre-rendered graphics objects 302 are stored separately from the traces and the metadata. In some embodiments, tags or naming conventions can be used to associate a trace with a specific set of pre-rendered graphics objects 302. Compared to storing a screenshot of a ball trajectory from the game, a trace is typically significantly smaller in size. For example, a trace comprising 200 points, each having four components (i.e., an x-, y- and z-coordinate for location, and an associated time), along with some metadata, requires approximately 5 kB of storage.

In some embodiments, in order to save storage space, the trace data can be compressed prior to sending the trace data to the computing device, in order to reduce storage and network requirements. This compression can be accomplished, for example, by setting one or more thresholds to reduce the number of observed points in a trace. The thresholds may vary depending on the particular implementation and the degree to which the data should be reduced. For example, in some implementations, a threshold is set based on how much the angle of the ball relative to the ground changes between a number of consecutive points. Assume, for example, that the angle is essentially the same for five consecutive observation points. This would be a relatively reliable indication that the ball is moving in a straight line and that some of these observation points could be safely removed in order to save data storage space. This is particularly true for the part of the trajectory that occurs before the ball lands on the ground. In some cases the savings in storage space can be as large as 50%, and sometimes even more (for example, if the ball does not bounce on the ground upon landing) compared to the initial trace.

In some embodiments, there may be restrictions on which observed points may or may not be discarded. For example, in order to be able to draw a realistic representation on the computing device, preferably all “bounce points” (i.e., the observed points where the ball touches the ground) should be kept. It should also be realized that this is merely one example of a compression mechanism that may be used and that other suitable compression methods are available and may be useful in this context.

After the compressed trace has been received by the computing device, it may be desirable to increase the resolution of the trace again to render the trace on the computing device in an aesthetically pleasing way. This can also be done in a variety of ways. In some implementations, the trajectory is divided into a plurality of arcs, where each arc represents a section of the trajectory between a starting point and an ending point on the ground. For example, a hit that results in the ball bouncing three times gets four arcs (i.e., one long arc and three smaller arcs).

A Catmull-Rom spline is then fit to each arc. A Catmull-Rom spline is a type of Hermite spline, i.e., a piecewise polynomial curve that is defined by its endpoints and tangents. The curve passes through all of the received observed points for the arc. The curve is smooth and has a continuous first derivative, which makes it particularly useful for a variety of applications such as curve fitting, computer graphics, and animations. Once a Catmull-Rom spline has been determined for each arc, it is possible to increase the resolution (i.e., points per unit of time and/or distance) to a desired level prior to rendering by picking any number of points along the spline. For example, a point can be generated every 0.01 seconds, or every 0.001 seconds in order to achieve an aesthetically pleasing trajectory on the computing device. However, it should be noted that Catmull-Rom spline is merely one example, and that other curve fitting mechanism can also be used, depending on the particular embodiment at hand.

In some embodiments, rather than sending a series of coordinates and associated times to the computing device, an approximation of the trajectory (or parts thereof) can be provided, for example by polynomial fitting to the observed points in a similar way, and then sending the parameters for the polynomial to the computing device for rendering on the device. This may save significant storage and bandwidth, and even though there could be the possibility of losing some accuracy when doing the polynomial fit, the resulting approximation may still be sufficiently accurate for displaying on the computing device for the user's purposes. The exact choice of which (if any) compression mechanism or combination of various compression mechanisms to use will depend on the particular circumstances at hand.

Next, in block 106, a trace representing the trajectory is rendered at the desired resolution on top of the color buffer, using the MVP matrix, and the depth buffer data to determine whether any parts of the trace of the flying object should be occluded in the color buffer. In some embodiments, the rendering of the trace, in contrast to any previous rendering of the scene (initial color/depth buffer creation), is done in its entirety on a user's computing device, for example, in a web browser window on a laptop, tablet computer, mobile phone, or similar computing device, by either a custom or a conventional rendering engine, such as WebGL (Web Graphics Library). WebGL is a JavaScript Application Programming Interface (API) that allows 3D graphics to be rendered in a web browser, without the need for plugins, and is based on the OpenGL ES 2.0 specification, which is a low-level graphics API that is widely used on mobile devices and other platforms.

In some embodiments, the steps performed in order to render the trace on top of the color buffer are analogous to the conventional 3D rendering methods described above. First, the color buffer and depth buffer are cleared. Second, the color buffer and depth buffer are set to the color buffer and depth buffer, respectively, from the current pre-rendered graphics object, which is the view the user will see on her computing device.

Which one among potentially several pre-rendered graphics objects (e.g., the pre-rendered graphics object 304-308 of FIG. 3) to use can either be selected by the user, or be provided automatically by the system. Selecting a different pre-rendered graphics object from a set of pre-rendered graphics objects is analogous to changing a camera view in a TV production. In some embodiments, it is also possible to switch between different pre-rendered graphics objects, to mimic cuts on a TV production, based on different criteria, such as the starting or finishing position of the trace. For example, when the shot is first launched, a first pre-rendered graphics object 304 showing an overview of the shot may be displayed, followed by a second pre-rendered graphics object 306 or 308, showing a more zoomed in view of the area around the green.

In some embodiments it is possible to mimic camera movements (e.g., the camera “flying,” zooming, rotating, etc., to follow the golf ball). This can be accomplished, for example, by defining a camera trajectory through several contiguous pre-rendered graphics objects (i.e., a video). In some embodiments, the camera movements may simply be smaller movements, for example, simulating how a user might move a handheld camera when filming a shot. Essentially any type of camera movement that falls within these two extremes is possible, as long as there exists a series of pre-rendered graphics objects which have sufficient information about the CV parameters, and jointly form the video that describes the camera's movement. This may enhance the user's viewing experience even further.

Third, the trace is rendered, using the MVP matrix obtained from the CV parameters. The trace can be rendered either statically (i.e., a still image of a full trace), or dynamically (i.e., animated, for example, by having a timer that steps forward and sequentially draws the different points included in the trace data). In some embodiments, user controls are provided, such that a user may, for example, change the rate at which the timer steps forward (e.g., to achieve slow motion or speeded up replays), or showing a reverse time representation of the trace that starts at the ending point for the shot and moves back towards the starting point for the shot. As described above, the depth buffer is used to determine if the trace should be rendered in front of or be occluded by other objects that the trace traverses in the color buffer.

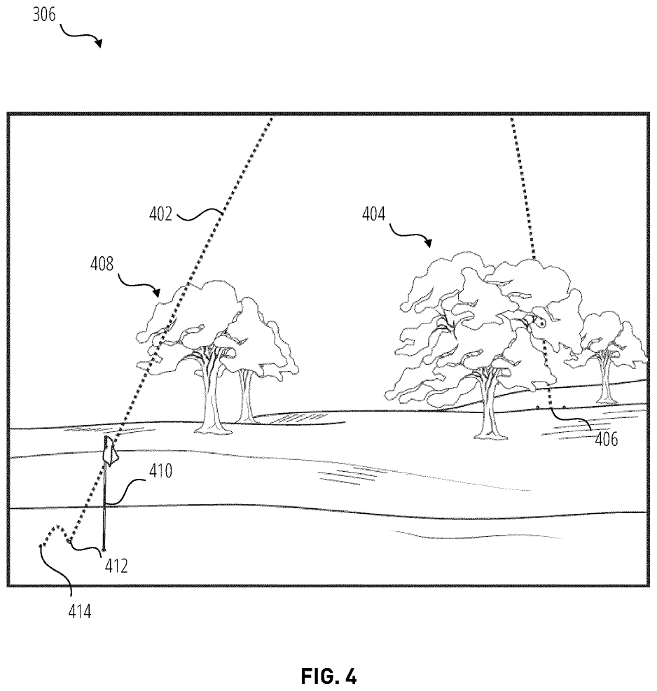

Finally, in block 108, 3D rendering method 100 draws the color buffer with the rendered trace on a graphical user interface on the computing device, which ends the process. As was mentioned above, typically this occurs in a web browser window on the computing device using conventional methods, but in some embodiments, it can be performed using custom software and hardware components. FIG. 4 shows an exemplary view of what a user may see on a graphical user interface, for example, in a web browser window. In particular FIG. 4 shows the pre-rendered graphics object 306 with a trace 402. As shown in FIG. 4, in the rendered view, the trace 402 shows the trajectory traversed by the ball from a starting point 406 to a landing point 412, where it bounces, and eventually reaches its ending point 414. The trace 402 shows how the ball moves behind the tree 404, in front of the tree 408, and behind the flag 410, as viewed from the camera's viewpoint, providing a realistic illustration of the trajectory to the user on his computing device.

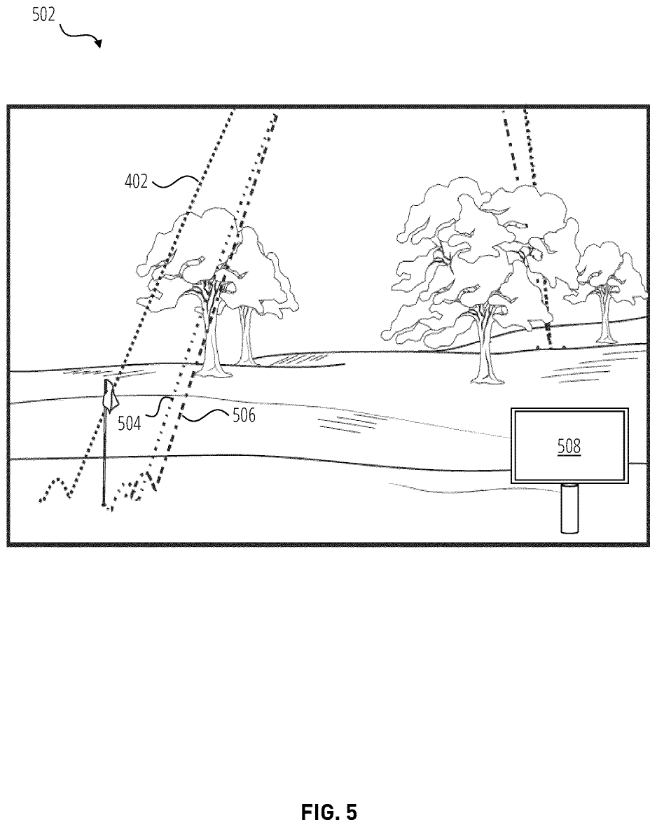

In some embodiments, multiple traces can be generated to create a “fireworks” effect for a given pre-rendered graphics object. This makes it possible to make a direct comparison of different traces, either from an individual user, for example, for purposes of comparing current and historical data for a particular hole, or to compare ball trajectories for several users for the hole. FIG. 5 shows such a pre-rendered graphics object 502, corresponding to the pre-rendered graphics object 306 illustrated in FIG. 4, and including additional traces 504 and 506.

In some embodiments, it is also possible to render additional or optional objects in the color buffer that may enhance the user experience. For example, as shown in FIG. 5, there can be a sign 508 showing optional information such as the ball and/or wind speed, there can be an arrow showing where the flag is on the green or showing an optimal landing spot, or there can be a deer running across the fairway, etc. Any such optional object can have associated depth buffer information, allowing the trace to be drawn in front of or behind the optional object, from the camera's viewpoint.

In some embodiments, a browser window may be divided into several smaller windows, such that different pre-rendered graphics objects can be viewed simultaneously by a user. For example, an instructor may be able to view several students hits on a given hole (or several holes, or even the entire golf course) side-by-side, or to simultaneously view pre-rendered graphics objects showing the same hole, for a single student from different angles, etc. Essentially any combination of desired pre-rendered graphics objects can be presented in the different sub-windows of the browser window.

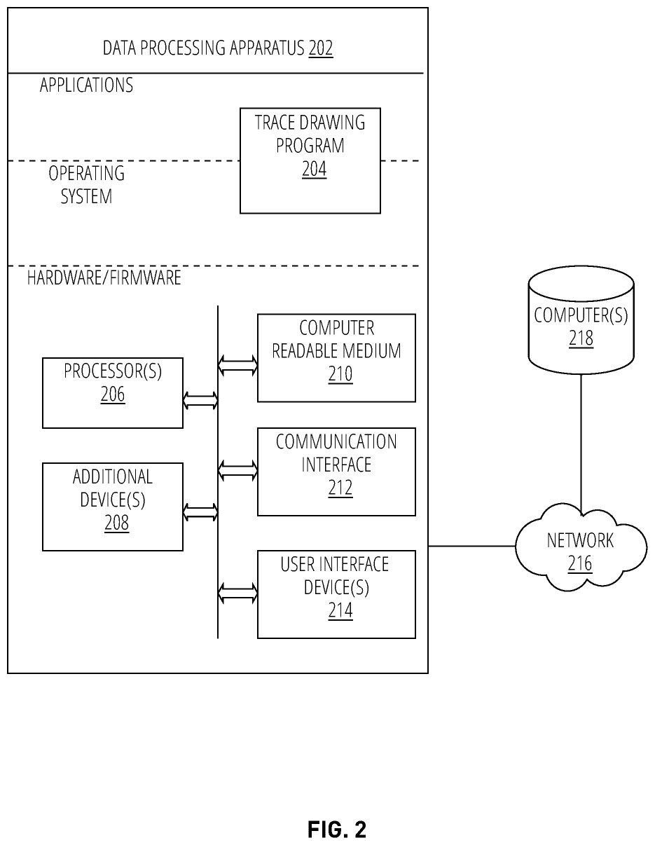

Distinct types of computers can be used to perform the above-described functionality. The essential elements of a computer are a processor for performing instructions and one or more memory devices for storing instructions and data. As used herein, a “computer” can include a server computer, a client computer, a personal computer, embedded programmable circuitry, or a special purpose logic circuitry. FIG. 2 is a schematic diagram of a data processing system including a data processing apparatus 202, which can be a computer that is programed to perform method 100, e.g., computing device 614. The data processing apparatus 202 can be connected with one or more computer(s) 218 through a network 216.

The data processing apparatus 202 can include various software modules, which can be distributed between an applications layer and an operating system. These can include executable and/or interpretable software programs or libraries, including a trace drawing program 204, for example. The number of software modules used can vary from one implementation to another. Also, in some cases, the trace drawing program 204 can be implemented in embedded firmware, and in other cases, the trace drawing program 204 can be implemented as software modules that are distributed on one or more data processing apparatus connected by one or more computer networks or other suitable communication networks.

The data processing apparatus 202 can include hardware or firmware devices including one or more processor(s) 206, one or more additional device(s) 208, a non-transitory computer readable medium 210, a communication interface 212, and one or more user interface device(s) 214. The processor(s) 206 is capable of processing instructions for execution within the data processing apparatus 202, such as instructions (e.g., of the trace drawing program 204) stored on the non-transitory computer readable medium 210, which can include a storage device such as one of the additional device(s) 208.

In some implementations, the processor(s) 206 is a single or multicore processor, or two or more central processing units (CPUs). The data processing apparatus 202 uses its communication interface 212 to communicate with one or more computer(s) 218, for example, over the network 216. Thus, in various implementations, the processes described can be run in parallel, concurrently, or serially, on a single or multi-core computing machine, and/or on a computer cluster/cloud, etc.

Examples of user interface device(s) 214 include a display, a touchscreen display, a speaker, a microphone, a tactile feedback device, a keyboard, a mouse, and a headset or heads-up display of a virtual reality or augmented reality environment system. Moreover, the user interface device(s) 214 need not be local device(s) but can be remote from the data processing apparatus 202, e.g., user interface device(s) 214 accessible via one or more networks 216. For example, the user interface device(s) 214 can be a smartphone or a tablet computer of the user, e.g., for an augmented reality implementation. The data processing apparatus 202 can store instructions that implement operations as described in this document, for example, on the non-transitory computer readable medium 210, which can include one or more additional device(s) 208, for example, one or more of a floppy disk device, a hard disk device, an optical disk device, a tape device, and a solid-state memory device (e.g., a RAM drive).

Moreover, the instructions that implement the operations described in this document can be downloaded to the non-transitory computer readable medium 210 over the network 216 from one or more computer(s) 218 (e.g., from the cloud). In some implementations, the data processing apparatus 202 is a smartphone or a tablet computer. In some implementations, the RAM drive is a volatile memory device to which the instructions are downloaded each time the computer is turned on.

FIG. 6 shows a system 602 in accordance with some embodiments, in which various embodiments of the above-mentioned 3D rendering method 100 can be implemented. The system includes a game report database 608 and a graphics objects database 610. The game report database 608 and graphics objects database 610 communicate over a network 612 with one or more computing devices 614, which contain a trace drawing program 204 that performs the above-mentioned operations to render one or more traces within one or more pre-rendered graphics objects on a GUI of the computing device 614. In some embodiments, the system 602 can also include a computer game 604, whereas in other embodiments, the computer game 604 is a free-standing component that communicates with the system 602 and provides game reports 606 through a suitable API.

As was described above and is shown in FIG. 6, a user plays a computer game 604, which generates a set of game reports 606. These game reports include trace data (i.e., 3D locations and associated times), and typically also include metadata, such as player ID, which hole was played, etc. In some embodiments, the game reports 606 may optionally be enhanced by calculating additional data based on the trace data, such as ball speed, launch angle, carry, and other parameters that may be of interest. The game reports 606 are saved in the game report database 608. The graphics objects database 610 contains a large number of pre-rendered graphics objects that are associated with the course(s) that can be played in the computer game 604. It should be noted that often, the graphics objects database 610 contains a large number of pre-rendered graphics objects that are associated with the course(s) that can be played in a wide variety of computer games 604 and is not limited to course(s) that can be played in a single game 604. The game report database 608 and graphics objects database 610 can be located in the same or in different physical locations and can be accessed over the network 612, which can be a wired or wireless network or a combination thereof, using various conventional protocols. Typically, such data is accessed at the request of the trace drawing program 204 and then rendered on the computing device 614, as described above.

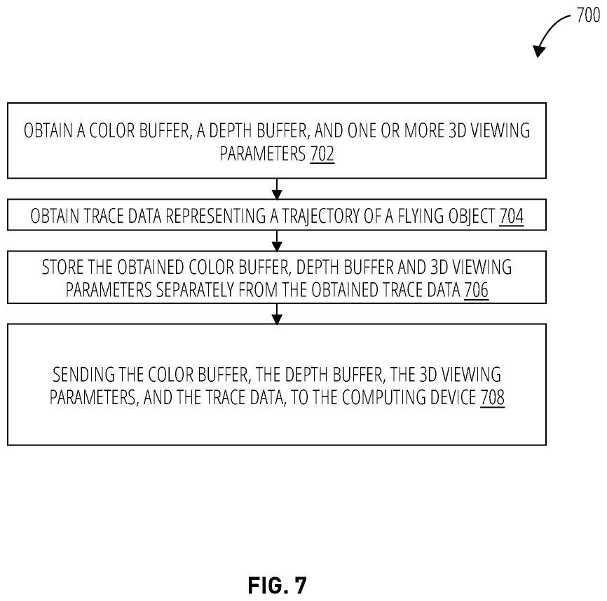

FIG. 7 shows a server implemented method 700 for providing data representing a 3D scene to a computing device, as described above, in accordance with some embodiments. In block 702, a color buffer, a depth buffer, and one or more 3D viewing parameters are obtained, which jointly form a pre-rendered graphics object as described above. Obtaining in this context can either refer to creating the color buffer, depth buffer and 3D viewing parameters on a backend server, or simply receiving already created color buffer, depth buffer and 3D viewing parameters from another system component, or it might be a combination of the two alternatives, where certain items are received while others are created on the backend server. In block 704, trace data representing a trajectory of a flying object is obtained, for example, from a game report 606, as described above, although other methods are also possible.

Next, in block 706, the obtained color buffer, depth buffer and 3D viewing parameters are stored separately from the obtained trace data, for example, by storing the trace data in the game report database 608 and storing the pre-rendered graphics objects in the database 610. In block 708, the pre-rendered graphics object(s) and trace data are sent to a computing device 614 over the network 612, which ends the method 700. It should be noted that the pre-rendered graphics object(s) and trace data need not be sent at the same time. For example, in some embodiments, a computing device may be “preloaded” with pre-rendered graphics objects for a particular game before the game starts, and then as the game progresses, only the trace data is provided to the computing device, where it is rendered together with the appropriate pre-rendered graphics object(s) that have already been downloaded.

The embodiments of the present invention described herein also relates to a computer software function for representing trajectories on a graphical user interface of a computing device, according to what has been described above. Such a computer software function is then arranged to, when executing, perform the above-described operations, which are also recited in the claims. The computer software function is arranged to execute on physical or virtual hardware of the computing device 614 and/or data processing apparatus 202, as described above.

Embodiments of the subject matter and the functional operations described in this specification can be implemented in digital electronic circuitry, or computer software, firmware, or hardware, including the structures disclosed in this specification and their structural equivalents, or in combinations of one or more of them. Embodiments of the subject matter described in this specification can be implemented using one or more modules of computer program instructions encoded on a non-transitory computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various computing model infrastructures, such as web services, distributed computing, and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and one or more processors of any suitable digital computer. Generally, a processor will receive instructions and data from a read-only memory (ROM) or a random-access memory (RAM), or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media, and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; CD-ROM and DVDROM disks; network attached storage; and various forms of cloud storage. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display), OLED (organic light emitting diode), or other monitor, for displaying information to the user and a keyboard and a pointing device, e.g., a mouse or a trackball, by which the user can provide input to the computer. Other kinds of devices can be used to provide for interaction with a user as well; for example, feedback provided to the user can be sensory feedback, e.g., visual feedback, auditory feedback, or tactile feedback; and input from the user can be received in various forms, including acoustic, speech, or tactile input.

The computing system can include clients and servers. A client and server are generally remote from each other and interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any suitable combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an internetwork (e.g., the Internet), and peer-to-peer networks (e.g., ad hoc peer-to-peer networks).

While this specification contains many implementation details, these should not be construed as limitations on the scope of the invention or of what may be claimed, but as descriptions of features specific to implementations of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination. Thus, unless explicitly stated otherwise, or unless the knowledge of one of ordinary skill in the art clearly indicates otherwise, any of the features of the embodiment described above can be combined with any of the other features of the embodiment described above.

Similarly, while operations are depicted in the drawings in a particular order, this should not be understood as requiring that such operations be performed in the order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments. The described program components and systems can be integrated into a single software product or packaged into multiple software products.

Thus, embodiments of the invention have been described. Other embodiments are within the scope of the following claims. For example, while the above embodiments have referred to a 3D rendering engine that generates a 2D image from a 3D model, the same general principles can be applied to real-life pictures and associated captured depth information.

Further, while the trace has been described above with respect to a single view and display on a computing device such as a mobile phone or tablet computer, in some embodiments, there may be different views that are created for the left and right eyes, respectively, of a user. When such views are displayed in a virtual reality and/or augmented reality headset, for example, the user would experience this as a 3D view of the ball trajectory, which may even further enhance the user's experience.

In some embodiments, it is possible to simulate what would happen if certain physical parameters change, e.g., “what would the trace look like if the wind increased by 10 m/s,” or “what would the trace look like if the same shot was made at a high altitude rather than at sea level,” or “what would my hits look like if I consistently aimed 5 m to the left,” and so on. Such different scenarios can be displayed on the user's computing device, for example, in a similar manner to that shown in FIG. 5. Various models can be applied to the collected trace data, either prior to sending the trace data to the user's computing device, or after the trace data has been received by the user's computing device, and prior to rendering the trace on the user's computing device. Conversely, the simulations can be used “in reverse” to answer questions like “how windy would it need to be for me to miss the fairway?” and so on. As can be understood, this ability to provide simulations enables the generation of a more or less limitless number of “hypotheticals” on the user's computing device.

Yet further, in some embodiments, a user may choose to render trace data that was previously recorded for a different user, and compare her own trace data with that other user's trace data. For example, this can enable a user to “asynchronously” play a game with a friend without having to be present at the same time, or to compare her own game to that of a professional player, just to mention a few possibilities.

In some embodiments, the drawing of the trace on the user's device may stop when the ball first reaches the ground, i.e., at the landing point 412 of FIG. 4, rather than the ending point 414, such that any bouncing is not included. In many situations, it may be sufficient to draw the trace only up to the landing point 412. This may be particularly true for the various types of “what if” scenarios described in the previous paragraph, since it would often be difficult or impossible to predict what any subsequent bouncing would look like in a hypothetical scenario. Detecting when to stop drawing the trace can be made by the computing device, for example, by observing when there is a sudden and abrupt change of direction of the trace (i.e., when the ball bounces on the ground). Further, in some games, the only value of a shot may be to hit a particular target, rather than assigning value to simply getting the ball closer to the target, as in a traditional golf game, and in such situations, it may also make sense to stop drawing the trace on the user's device when the target has been hit. Thus many variations are possible based on the particular setup of the game.

Thus, many variations to the above examples lie well within the scope of the attached claims and within the capabilities of a person having ordinary skill in the art.

### EMBODIMENTS

Although the present invention is defined in the attached claims, it should be understood that the present invention can also (alternatively) be defined in accordance with the following embodiments:

1. A three-dimensional rendering method for a computing device, comprising:
receiving a color buffer, a depth buffer, and one or more three-dimensional viewing parameters, the color buffer providing a two-dimensional representation of a three-dimensional space;
receiving trace data representing a trajectory of a flying object in the three-dimensional space;
rendering a trace from the trace data representing the trajectory on top of the received color buffer, and using depth buffer data to determine whether the trace of the flying object should be occluded by any objects in the received color buffer; and
drawing the color buffer with the rendered trace on a display device.
   2. The method of embodiment 1, wherein the three-dimensional viewing parameters include a model viewport projection matrix, and wherein the model viewport projection matrix is used when rendering the trace on top of the color buffer.
   3. The method of embodiment 1, wherein receiving the color buffer comprises:
preloading the color buffer separately from receiving the trace data.
   4. The method of any one of embodiments 1 to 3, wherein the trace data includes a series of points in three-dimensional space and a corresponding time for each point.
   5. The method of embodiment 4, wherein rendering the trace includes rendering the trace either statically based on the series of points, or rendering the trace dynamically as an animation based on the series of points and the corresponding time for each point.
   6. The method of any one of embodiments 1 to 5, wherein the color buffer represents an image of an environment through which the flying object passes.
   7. The method of any one of embodiments 1 to 5, wherein the color buffer represents a three-dimensional animated view in a game.
   8. The method of any one of embodiments 1 to 7, wherein the method is performed a plurality of times for different color buffers, depth buffers, traces, and/or three-dimensional viewing parameters, and wherein the color buffers with the traces are drawn in several smaller sections within a browser window on the computing device.
   9. The method of any one of embodiments 1 to 8, further comprising rendering one or more optional objects on top of the color buffer.
   10. The method of embodiment 9, wherein the one or more optional objects include static or movable objects.
   11. The method of any one of embodiments 1 to 10, further comprising:
receiving a selection of one or more color buffers among a plurality of color buffers, or automatically selecting one or more color buffer among a plurality of color buffers.
   12. The method of any one of embodiments 1 to 11, further comprising rendering several traces representing several trajectories of the same flying object under different circumstances, or several trajectories representing different flying objects.
   13. The method of any one of embodiments 1 to 12, wherein the trace data is received in a compressed format and is decompressed by the computing device prior to rendering the trace.
   14. The method of any one of embodiments 1 to 13, wherein the display device is integrated in the computing device.
   15. A system for rendering a three-dimensional scene on a computing device, comprising:
a memory; and
a processor, wherein the memory contains instructions that, when executed by the processor perform a method in accordance with any one of any one of embodiments 1-13.
   16. A non-transitory, computer-readable storage medium containing instructions that when executed by a computing device cause the computing device to perform a method in accordance with any one of any one of embodiments 1-13.
   17. A method for preparing data representing a three-dimensional scene to be rendered on a computing device, comprising:
obtaining a color buffer, a depth buffer, and one or more three-dimensional viewing parameters, the color buffer providing a two-dimensional representation of a three-dimensional space;
obtaining trace data representing a trajectory of a flying object in the three-dimensional space;
storing the obtained color buffer, depth buffer and three-dimensional viewing parameters separately from the obtained trace data; and
sending the color buffer, the depth buffer, the three-dimensional viewing parameters, and the trace data, to the computing device for rendering the three-dimensional scene on the computing device, wherein the trace data is sent separately from the color buffer, the depth buffer and the three-dimensional viewing parameters.
   18. The method of embodiment 17, wherein the three-dimensional viewing parameters include a model viewport projection matrix to be used when rendering the trace on top of the color buffer on the computing device.
   19. The method of embodiment 17, wherein the color buffer represents an image of an environment through which the flying object passes.
   20. The method of any one of embodiments 17 to 19, wherein the color buffer represents a three-dimensional animated view from a first viewpoint.
   21. The method of any one of embodiments 17 to 20, wherein the trace data includes a series of points in three-dimensional space and a corresponding time for each point.
   22. The method of any one of embodiments 17 to 21, wherein storing the trace data includes:
compressing the trace data; and
storing the trace data in a compressed format.
   23. The method of any one of embodiments 17 to 22, further comprising obtaining and storing several trajectories of the same flying object under different circumstances, or several trajectories representing different flying objects.
   24. A system for preparing data representing a three-dimensional scene to be rendered on a computing device, comprising:
a memory; and
a processor, wherein the memory contains instructions that, when executed by the processor perform a method in accordance with any one of embodiments 17 to 23.
   25. A non-transitory, computer-readable storage medium containing instructions that when executed by a computing device cause the computing device to perform a method in accordance with any one of embodiments 17 to 23.

1. A three-dimensional rendering method for a computing device, comprising:
receiving a color buffer, a depth buffer, and one or more three-dimensional viewing parameters, the color buffer providing a two-dimensional representation of a three-dimensional space;
receiving trace data representing a trajectory of a flying physical object in the three-dimensional space;
rendering a trace from the trace data representing the trajectory on top of the received color buffer, and using depth buffer data to determine whether the trace of the flying physical object should be occluded by any objects that the trace traverses in the received color buffer; and
drawing the color buffer with the rendered trace on a display device.

2. The method of claim 1, wherein the trace data has been captured by one or more radar sensors and/or one or more cameras, wherein the trace data comprises measured and/or estimated data about instantaneous location of the flying physical object as the flying physical object travelled through air.

3. The method of claim 1, wherein the color buffer, the depth buffer, and the one or more three-dimensional viewing parameters jointly form a pre-rendered graphics object, wherein the color buffer, the depth buffer, and the one or more three-dimensional viewing parameters are received from a first storage where the pre-rendered graphics object is stored, wherein the first storage stores pre-rendered graphics objects for use as shared resources, wherein the trace data is stored separately from the pre-rendered graphics objects.

4. The method of claim 1, wherein the one or more three-dimensional viewing parameters include a model viewport projection matrix, and wherein the model viewport projection matrix is used when rendering the trace on top of the color buffer.

5. The method of claim 1, wherein the one or more three-dimensional viewing parameters represent a position and an orientation of a camera.

6. The method of claim 1, wherein receiving the color buffer comprises:
preloading the color buffer separately from receiving the trace data.

7. The method of claim 1, wherein the color buffer, the depth buffer, and the one or more three-dimensional viewing parameters are received over a network from a database, and the trace data is received from a game report database,
wherein receiving the color buffer, the depth buffer, and the one or more three-dimensional viewing parameters comprises:
preloading the color buffer, the depth buffer, and the one or more three-dimensional viewing parameters for a particular game before the particular game starts; and
wherein rendering the trace is performed as the particular game progresses, wherein the rendering of the trace comprises:
rendering of the trace together with a pre-rendered graphical object that has already been downloaded.

8. The method of claim 1, wherein the trace data includes a series of points in the three-dimensional space and a corresponding time for each point in the series of points.

9. The method of claim 8, wherein rendering the trace includes rendering the trace either statically based on the series of points, or rendering the trace dynamically as an animation based on the series of points and the corresponding time for each point.

10. The method of claim 1, wherein the color buffer represents an image of an environment through which the flying physical object passes.

11. The method of claim 1, wherein the color buffer represents a three-dimensional animated space in a game.

12. The method of claim 1, wherein the method is performed a plurality of times for different color buffers, depth buffers, traces, and/or three-dimensional viewing parameters, and wherein the color buffers with the traces are drawn in several smaller sections within a browser window on the computing device.

13. The method of claim 1, wherein the trajectory represented by the trace data is a first trajectory to be rendered, wherein the flying physical object is a ball flying towards a particular hole, and wherein the method comprises:
receiving additional trace data representing further trajectories of flying balls in the three-dimensional space, wherein the first trajectory and the further trajectories are for balls, which are associated with different users, for the particular hole; and
rendering additional traces corresponding to the further trajectories on top of the color buffer with the trace.

14. The method of claim 1, further comprising rendering one or more optional objects on top of the color buffer, wherein the one or more optional objects are associated with depth buffer information usable when drawing traces in front or behind the one or more optional objects.

15. (canceled)

16. The method of claim 1, further comprising:
receiving a selection of one or more color buffers among a plurality of color buffers, or
automatically selecting one or more color buffers among a plurality of color buffers.

17. The method of claim 1, further comprising rendering several traces representing several trajectories of the same flying physical object under different circumstances, or several trajectories representing different flying physical objects.

18. The method of claim 1, wherein the trace data is received in a compressed format and is decompressed by the computing device prior to rendering the trace.

19. The method of any claim 1, wherein the display device is integrated in the computing device.

20. A system for rendering a three-dimensional scene on a computing device, comprising:
a memory; and
a processor, wherein the memory contains instructions that, when executed by the processor perform operations comprising:
receiving a color buffer, a depth buffer, and one or more three-dimensional viewing parameters, the color buffer providing a two-dimensional representation of a three-dimensional space;
receiving trace data representing a trajectory of a flying physical object in the three-dimensional space;
rendering a trace from the trace data representing the trajectory on top of the received color buffer, and using depth buffer data to determine whether the trace of the flying physical object should be occluded by any objects that the trace traverses in the received color buffer; and
drawing the color buffer with the rendered trace on a display device.

21. A non-transitory, computer-readable storage medium containing instructions that when executed by a computing device cause the computing device to perform operations comprising:
receiving a color buffer, a depth buffer, and one or more three-dimensional viewing parameters, the color buffer providing a two-dimensional representation of a three-dimensional space;
receiving trace data representing a trajectory of a flying physical object in the three-dimensional space;
rendering a trace from the trace data representing the trajectory on top of the received color buffer, and using depth buffer data to determine whether the trace of the flying physical object should be occluded by any objects that the trace traverses in the received color buffer; and
drawing the color buffer with the rendered trace on a display device.

22. A method for preparing data representing a three-dimensional scene to be rendered on a computing device, comprising:
obtaining a color buffer, a depth buffer, and one or more three-dimensional viewing parameters, the color buffer providing a two-dimensional representation of a three-dimensional space;
obtaining trace data representing a trajectory of a flying physical object in the three-dimensional space;
storing the obtained color buffer, the depth buffer, and the one or more three-dimensional viewing parameters separately from the obtained trace data; and
sending the color buffer, the depth buffer, the one or more three-dimensional viewing parameters, and the trace data, to the computing device for rendering the three-dimensional scene on the computing device, wherein the trace data is sent separately from the color buffer, the depth buffer and the one or more three-dimensional viewing parameters.

23. The method of claim 22, wherein the one or more three-dimensional viewing parameters include a model viewport projection matrix to be used when rendering a trace on top of the color buffer on the computing device.

24. The method of claim 22, wherein the color buffer represents an image of an environment through which the flying physical object passes.

25. The method of claim 22, wherein the color buffer represents a three-dimensional animated space view from a first viewpoint.

26. The method of claim 22, wherein the trace data includes a series of points in the three-dimensional space and a corresponding time for each point in the series of points.

27. (canceled)

28. The method of claim 22, further comprising obtaining and storing
several trajectories of the same flying physical object under different circumstances, or several trajectories representing different flying physical objects.

29. (canceled)

30. (canceled)
